(19) United States
(12) Patent Application Publication
(10) Pub. No.: US 2011/0249313 A1
(43) Pub. Date: Oct. 13, 2011

(54) OPTICALLY ACTIVE GLAZING WITH OVERVOLTAGE PROTECTION

(76) Inventor: Philippe Letocart, Raeren (BE)

(21) Appl. No.: 13/119,022

(22) PCT Filed: Nov. 19, 2009
(86) PCT No.: PCT/EP2009/065451

§ 371 Date: Jun. 22, 2011

(30) Foreign Application Priority Data
Dec. 20, 2008 (DE) 10 2008 064 357.2

(51) Int. Cl. G02F 1/15; G02F 1/03

(52) U.S. Cl. 359/265; 359/245

(57) ABSTRACT

The invention relates to a construction with an optically active glazing, whose optical properties can be varied by supplying electrical power, an electrical power source, which can be electrically connected to the optically active glazing via an electric circuit that contains a first pair of lines connected to the power source, as well as a circuit arrangement arranged in the electric circuit, which circuit arrangement is configured such that below a predetermined threshold voltage, it electrically connects the power source and the glazing and upon reaching the threshold voltage, it electrically isolates the power source from the glazing.

The invention is in the technical field of optically active glazings, in which optical properties can be varied by supplying electrical power, and relates, according to its generic type, to a construction in which such an optically active glazing is connected via an electric circuit to a power source.

In buildings and motor vehicles, optically active glazing in which optical properties can be selectively varied by supplying electrical power are increasingly used, for example, to steplessly regulate the amount of incident light by a different optical permeability (transparency) of the glazing.

Generic glazings as such are well known and already variously described in the patent literature. They include, for example, electrochromic glazings that include an optically active layer made of an electrochromic material that is capable of reversibly storing and releasing cations. By application of electrical voltages of different polarities, the storage and/or release of the cations can be controlled in order to thus influence the transparency of the electrochromic glazing. Reference is made, merely by way of example, to the European patents EP 0338876, EP 0408427, EP 0628849, and the U.S. Pat. No. 5,985,486, in which electrochromic glazings are described extensively.

Generic optically active glazings are also, for example, PDLC glazings (PDLC=Polymer Dispersed Liquid Crystal) that contain a liquid crystal layer as an optically active layer. The liquid crystals of the liquid crystal layer, which are randomly oriented without application of electrical voltage and scatter light greatly in this state, can be oriented in one direction by application of an electrical voltage, with the light crystals only slightly scattering light in this state because of an index of refraction adapted to the surroundings, such that the transparency of the liquid crystal layer increases greatly.

Generic optically active glazings are also, for example, SPD Glazings (SPD=Suspended Particle Device) that contain a layer of suspended particles as an optically active layer, where, in contrast to the PDLC glazings, instead of the light scattering, the light absorption of the optically active layer can be varied by application of an electrical voltage, to thus control the transparency of the SPD glazing.

It is common to the generic optically active glazings that they are irreversibly destroyed if an electrical voltage that exceeds a limiting voltage depending on the respective type is applied. If, for example, a voltage exceeding the limiting voltage is applied to an electrochromic glazing, gases can form in the glazing; dielectrics can be destroyed and the optically active layers can be oxidized, reduced, and decomposed. Apart from damaging the glazing, an accompanying functional impairment can also be relevant from a safety technology standpoint, for example, in the case of undesired overheating of interior spaces due to increased transparency of the glazing.

A possible cause for the application of inadmissibly high electrical voltages is improper operation by the user. Thus, for example, it cannot be ruled out in practice that an optically active glazing be connected to an electrical power source with an excessively high output voltage due to ignorance or inattention. In addition, electrochromic glazings have, with regard to the polarity of the voltage applied, for example, a specific terminal configuration depending on the respective construction, such that electrochromic glazings must be connected with suitable poling. Since the limiting voltage for reducing transparency is usually higher than for increasing transparency, the case may, in particular, occur that irreversible damage of the glazing is caused by an improperly poled power source.

Moreover, it cannot be ruled out that electrical power sources deliver inadmissibly high electrical voltages due to malfunctions.

Voltage spikes, as may occur, for example, in motor vehicles through actuation of an ignition system or, in general, during thunderstorms, are another frequent cause of inadmissibly high voltages in the electrical supply of optically active glazing. If, for example, an optically active glazing in a building is connected to the electric power grid, voltage spikes by which the glazing is irreversibly damaged can be generated by a lightning strike.

To prevent this, it is known to provide overvoltage protection within the electric power grid in buildings or in the onboard power system of motor vehicles, such that the optically active glazing is protected from voltage spikes of the system. US 2005/0063036 A1 discloses overvoltage protection in the electric circuit of the electrical supply unit. However, it has been demonstrated in practice that voltage spikes can be generated inductively by high-frequency electromagnetic alternating fields, as they, for example, can occur through actuation of the ignition system or during thunderstorms, even in the electric circuit between the system connection and the optically active glazing. In this case, overvoltage protection of the electrical system is not effective.

To prevent inductively generated voltage spikes in the electric circuit of the electrical power supply of the optically active glazing, it would be conceivable to arrange the grid connection as near as possible to the glazing or to keep the electrical lines between the system connection and the glazing as short as possible. Often such an approach is, however, not possible since the grid connection is usually bulky or the necessary electrical power is not feasible at the site of the glazing, such as, for instance on a façade or another area not protected from moisture, for safety technology reasons. It would also be conceivable to provide the electrical lines between the system connection and the glazing with metal shielding, but practice shows that the effectiveness of such shielding does not usually meet the practical requirements.

In contrast, the object of the present invention is to provide a capability by which damage to optically active glazings due to an inadmissibly high voltage can be reliably and safely avoided.

This and other objects are accomplished according to the proposal of the invention through a construction with the characteristics of the independent patent claim. Advantageous configurations of the invention are indicated through the characteristics of the subclaims.

According to the invention, a construction is shown that generically includes at least one optically active glazing, wherein at least one optical property, such as transparency, light scattering, light reflection, and/or coloring, can be varied by supplying electrical power, i.e., through application of an electrical voltage or an electrical current.

The term “optically active glazing” is generally understood in the context of the present invention to mean any glazing wherein at least one optical property can be controlled by supplying electrical power, for example, an electrochromic glazing, a PDLC glazing, or an SPD glazing. Preferably, the optically active glazing is an electrochromic glazing whose transparency can be varied by supplying electrical power. As emerges, in particular, from the publications mentioned in the introduction, electromagnetic glazings include at least one transparent substrate, for example, glass, onto which a layer made of an electrically conductive material is applied, as well as at least one layer made of an electrochromic material, for example, tungsten oxide, that is capable of reversibly storing or releasing cations. It is essential here that different oxidation states of the electrochromic material that correspond to the stored or released state of the cations have a different color, with one of these states usually transparent. By application of electrical voltages of different polarities, the storing or releasing of cations is controlled to selectively influence an optical transparency of the electrochromic glazing.

In the context of the present invention the term “glazing” merely characterizes the object as such without thereby restricting the property to glass for use as a transparent substrate.

The generic construction further includes an electrical power source (voltage and/or current source) that can be electrically conductively connected to the optically active glazing via an electric circuit that has a first pair of lines connected to the power source.

Furthermore, the construction according to the invention includes a circuit arrangement arranged in the electric circuit, which arrangement is configured such that below a predetermined (selectable) electrical limiting voltage, it electrically conductively connects the power source and the glazing to each other; and upon reaching the limiting voltage, it electrically isolates the power source from the glazing. In the context of the present invention, “limiting voltage” means, depending on the configuration of the optically active glazing, a maximum admissible operating voltage for the problem-free operation of the optically active glazing.

Through the construction according to the invention, it is thus possible, in an advantageous manner, to prevent applying an inadmissibly high electrical voltage to the optically active glazing such that damaging of the glazing is reliably and safely prevented. In particular, it is possible to prevent voltage spikes inductively generated by transient electromagnetic alternating fields in the electric circuit between the power source and the optically active glazing from impinging on the optically active glazing.

In an advantageous embodiment of the construction according to the invention, the circuit arrangement inside the electric circuit is arranged closer to the glazing than to the power source. The closer the circuit arrangement is arranged to the glazing, the lower the probability of inductively generated voltage spikes in the electric circuit between the power source and the glazing. Particularly advantageously, the circuit arrangement is arranged in the immediate vicinity or neighborhood of the glazing. For this, the circuit arrangement can, for example, be arranged on an exterior surface of the glazing or, in the case of a laminated layer structure, between the layers of the glazing.

In another advantageous embodiment of the construction according to the invention, the electric circuit includes an electrical distributor provided with a housing that electrically conductively connects the first pair of lines connected to the power source to least one second pair of lines or pair of contacts connected to the glazing. Here, the circuit arrangement is integrated into the housing of the distributor, as a result of which the circuit arrangement can be arranged close to the glazing in order to prevent inductively generated voltage spikes in the electric circuit between the power source and the glazing. On the other hand, the circuit arrangement can be inserted in a particularly simple structural manner into the electric circuit connecting the power source and the glazing.

Alternatively, it is, for example, also possible to configure the circuit arrangement as a module and to connect the circuit arrangement to input connectors of the distributor, with the circuit arrangement in this case connecting the first pair of lines connected to the power source to the distributor. For example, for this, the circuit arrangement could be plugged into the input connectors of the electrical distributor such that a conventional optically active glazing can be retrofitted with such a circuit arrangement.

In another advantageous embodiment of the construction according to the invention, the circuit arrangement includes a first short-circuit bridge, by means of which the two lines of the first pair of lines connected to the power source can be electrically conductively connected to each other. The first short-circuit bridge has at least one first electrical component by which the first short-circuit bridge is divided into two bridge sections. This first electrical component is configured such that below the limiting voltage, it electrically isolates the two bridge sections and upon reaching the limiting voltage, it electrically conductively connects them to each other.

In an advantageous configuration of the above embodiment of the invention, the first electrical component includes a spark gap, i.e., a discharge space between two electrodes, with the spark gap configured such that upon reaching the limiting voltage it becomes conductive, i.e., electrically conductively connects the two electrodes to each other across the discharge space.

In another advantageous configuration of the above embodiment of the invention, the first electrical component includes at least one pair of diodes connected in antiparallel (bidirectional diode or diac), whose breakdown voltages are selected such that they become electrically conductive upon reaching the limiting voltage.

In another advantageous configuration of the above embodiment of the invention, the first electrical component includes at least one pair of zener diodes connected in antiserial, whose breakdown voltages are selected such that they become electrically conductive upon reaching the limiting voltage.

In another advantageous configuration of the above embodiment of the invention, the first electrical component includes at least one transistor, for example, a bipolar transistor or a field effect transistor, whose control connection is connected via a second electrical component to at least one of the two lines of the first pair of lines connected to the power source. Here, the second electrical component is configured such that upon reaching the limiting voltage, the control connection applies a control voltage by which the transistor is switched to passage.

For example, for this, the control connection of the transistor is electrically conductively connected to a pickup of a voltage divider (e.g., series connection of ohmic resistors), with the voltage divider arranged in a first bridge line, by which the two lines of the first pair of lines connected to the power source are connected to each other. The voltage divider is configured such that upon reaching the limiting voltage, a voltage through which the transistor is switched to passage is picked up.

Alternatively, the second electrical component can include at least one diode or a serial connection of a plurality of diodes) [sic], with a forward voltage of the diode selected such that the transistor is switched to passage upon reaching the limiting voltage.

In the above embodiments of the invention, it can further be advantageous if the electric circuit between the power source and the glazing, in particular the circuit arrangement, is provided with a fuse by which the electric circuit between the power source and the glazing is interrupted upon reaching a predetermined (selectable) threshold circuit strength. Through this measure, it can be advantageously accomplished that in the event of damage or failure of the first electrical component, a current in the electric circuit between the power source and the glazing is interrupted. It would also be conceivable, alternatively or additionally, to insert a dropping resistor to limit current in the electric circuit between the power source and the optically active glazing.

In another advantageous embodiment of the construction according to the invention, the circuit arrangement has a relay actuated by an actuator that is arranged such that the electric circuit between the power source and the glazing can be interrupted. Here, the actuator for actuation of the relay is arranged in a second bridge line that electrically connects the two lines of the first pair of lines connected to the power source. The actuator is configured such that below the limiting voltage, it closes the relay and upon reaching the limiting voltage, it opens the relay.

In an advantageous configuration of the above embodiment of the invention, the circuit arrangement is provided with a second short-circuit bridge connected in parallel to the actuator, by which the two lines of the first pair of lines connected to the power source can be connected electrically conductively. Here, the second short-circuit bridge has at least a third electrical component by which the short-circuit bridge is divided into two bridge sections, with the third electrical component configured such that below a predetermined (selectable) threshold voltage, it electrically isolates the two bridge sections and upon reaching the threshold voltage, it connects them electrically conductively to each other. As the third electrical component, it is possible to use at least one pair of antiparallel-connected diodes whose breakdown voltages are selected such that upon reaching the threshold voltage, they become electrically conductive or at least one pair of antiserial-connected zener diodes whose breakdown voltages are selected such that upon reaching the threshold voltage, they become electrically conductive.

### BRIEF DESCRIPTION OF THE DRAWINGS

The invention is now explained in greater detail using exemplary embodiments with reference to the accompanying figures. They depict:

FIG. 1 a schematic depiction of an exemplary embodiment of the construction according to the invention with a circuit arrangement;

FIG. 2 a schematic circuit diagram of the construction of FIG. 1 with one configuration of the circuit arrangement;

FIG. 3 a schematic circuit diagram of the construction of FIG. 1 with another configuration of the circuit arrangement;

FIG. 4 a schematic circuit diagram of the construction of FIG. 1 with another configuration of the circuit arrangement;

FIG. 5 a schematic circuit diagram of the construction of FIG. 1 with another configuration of the circuit arrangement;

FIG. 6 a schematic circuit diagram of the construction of FIG. 1 with another configuration of the circuit arrangement;

FIG. 7 a schematic circuit diagram of the construction of FIG. 1 with another configuration of the circuit arrangement.

### DETAILED DESCRIPTION OF THE DRAWINGS

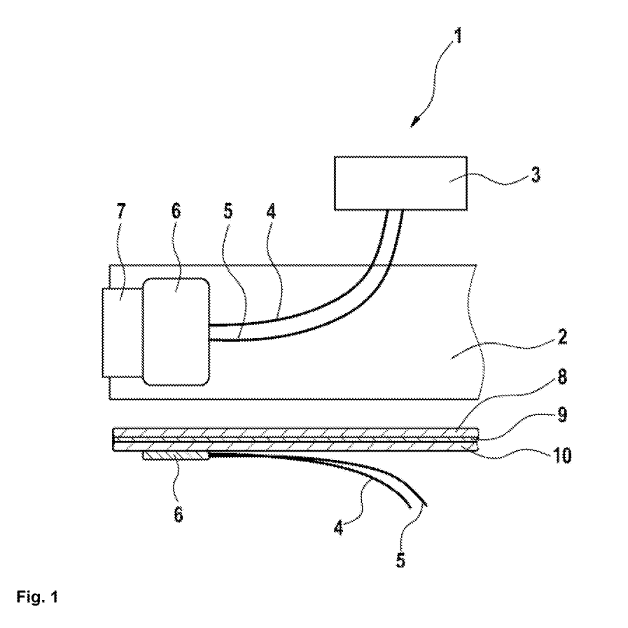

FIG. 1 depicts, in a top view and a cross-sectional view, a construction designated overall with the reference character 1 with an optically active glazing 2. Here, the optically active glazing is, for example, an electrochromic glazing, whose (optical) transparency can be varied by supplying electrical power.

The optically active glazing 2 has a laminated layer structure, with a transparent (e.g., glass) first substrate 8 and a transparent (e.g., glass) second substrate 10, onto which, in each case, as electrically conductive layer is applied. Between the two substrates 8, 10, a layer sequence with a plurality of layers designated overall with the reference character 9 is arranged. The layer sequence 9 includes at least one optically active layer made, for example, of tungsten oxide, an ion-conductive layer, for example, a polymer layer or an inorganic layer (e.g., a ceramic layer made of silicon oxide, tantalum oxide, or hafnium oxide), as well as, as a counter electrode, for example, one layer made of nickel oxide, iridium oxide, or vanadium oxide. The various layers of the layer sequence 9 of the optically active glazing 2 are well known to the person skilled in the art, for example, from the printed publications mentioned in the introduction, such that it is unnecessary to go into further detail here. In FIG. 1, the various layers of the layer sequence 9 are not depicted in detail.

The construction 1 further includes an electrical power source 3, that can be electrically connected via an electric circuit to the optically active glazing 2 to supply the glazing 2 with electrical power (DC current and/or DC voltage). The electric circuit includes a pair of lines connected to the power source 3 with a first electrical line 4 and a second electrical line 5 that are connected in a distributor 6 to a blade terminal 7. The blade terminal 7 contacts the electrically conductive layers of the optically active glazing 2 applied on the two substrates 8, 10.

The electrical distributor 6 is provided as a distributor box with a housing that is made, for example, of a plastic material. The distributor 6 is in contact with an exterior surface of the second substrate 10 and is, for example, glued to the exterior surface. Inside the housing of the electrical distributor 6, a circuit arrangement 11 is integrated within the electric circuit connecting the power source 3 to the optically active glazing 2 (not shown in FIG. 1). The circuit arrangement 11 is thus located in the immediate vicinity of the optically active glazing 2.

The optically active glazing 2 can be impinged on only up to a maximum limiting voltage without damage being caused. For this, the circuit arrangement 11 is configured such that below this limiting voltage, it connects the power source 3 and the optically active glazing 2 electrically conductively to each other and upon reaching this limiting voltage, it electrically isolates the power source 3 from the optically active glazing 2.

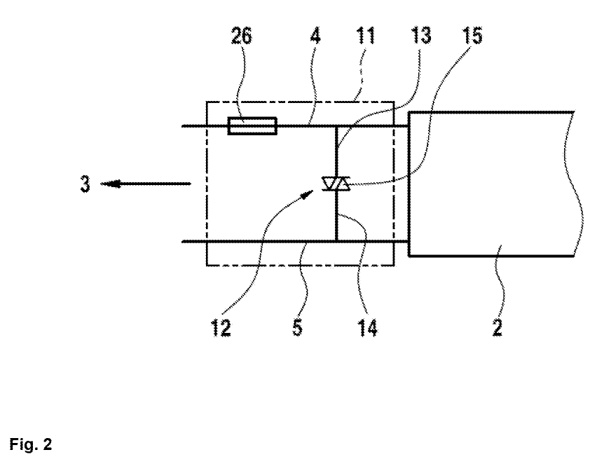

Referring now to FIG. 2 through 7, various configurations of the circuit arrangement 11 are explained using schematic circuit diagrams for the construction of FIG. 1. FIG. 2 through 7 depict in each case the electrical connection of the various circuit arrangements 11 to the optically active glazing 2. The arrow pointing to the left in FIG. 2 through 7 symbolizes the electrical connection to the power source 3. The circuit arrangement 11 per se is represented in each case by a borderline.

FIG. 2 through 5 depict in each case configurations of the circuit arrangement 11, in which the circuit arrangement 11 includes a first short-circuit bridge 12, by which the lines 4, 5 connected to the power source 3 can be electrically conductively connected. The first short-circuit bridge 12 includes in each case a first electrical component, by which it is divided into a first bridge section 13 and a second bridge section 14. Here, the first electrical component is configured such that below the limiting voltage, it electrically isolates the two bridge sections 13, 14 and upon reaching the limiting voltage, it connects them electrically conductively to each other.

First, consider FIG. 2, in which a first configuration of the circuit arrangement 11 is depicted. According to it, a first diac 15, i.e., a pair of antiparallel-connected diodes is included in the first short-circuit bridge 12 as the first electrical component. The breakdown voltages of the two diodes of the first diac 15 are selected here such that upon reaching the limiting voltage of the optically active glazing 2, they become electrically conductive, such that the two bridge sections 13, 14 and thus the lines 4, 5 connected to the power source 3 are short-circuited. Alternatively, it would be equally possible to provide as a first electrical component a pair of antiserial-connected zener diodes whose breakdown voltages are selected such that they become electrically conductive upon reaching the limiting voltage.

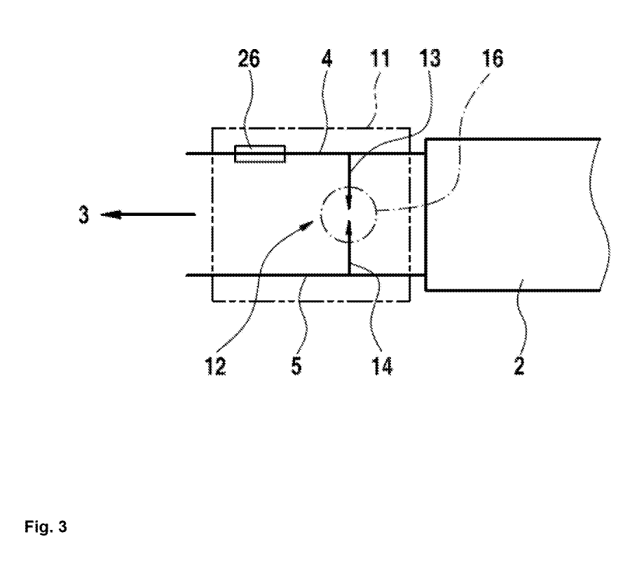

FIG. 3 depicts a second configuration of the circuit arrangement 11. According to it, a spark gap 16 is included in the first short-circuit bridge 12 as the first electrical component. The breakdown voltage of the spark gap 16 is selected here such that upon reaching the limiting voltage of the optically active glazing 2, the two bridge sections 13, 14 and thus the lines 4, 5 connected to the power source 3 are short-circuited across the spark gap 16.

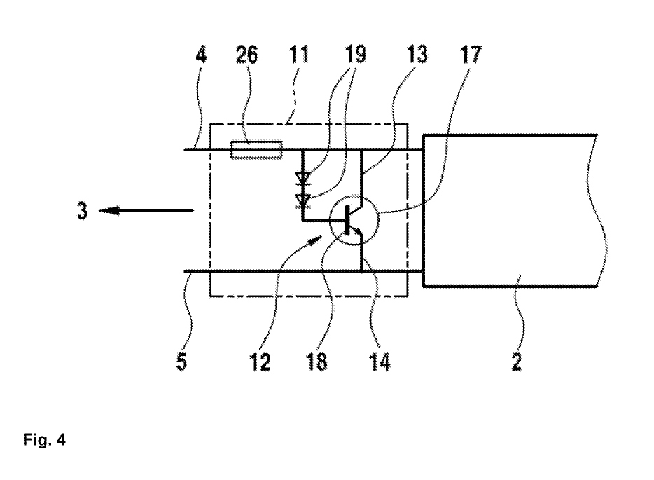

The first and second configurations of the circuit arrangement 11 shown in FIGS. 3 and 4, are suitable, above all, for optically active glazings 2 with a relatively high operating voltage that is, for example, more than 100 V, such that their limiting voltage is above 100 V and can, for example, be several hundred volts.

FIG. 4 depicts a third configuration of the circuit arrangement 11. According to it, a bipolar transistor 17 (npn- or pnp-transistor) is included in the first short-circuit bridge 12 as the first electrical component, with the load path of the bipolar transistor 17 part of the short-circuit bridge 12. A control connection 18 of the bipolar transistor 17 is electrically conductively connected to the first line 4 via two diodes 19 serially connected to each other. The two diodes 19 have a forward voltage such that, on the control connection 18 of the bipolar transistor 17, upon reaching the limiting voltage, the load path of the bipolar transistor 17 is switched to passage such that the two bridge sections 13, 14 and thus the electrical lines 4, 5 connected to the power source 3 are short-circuited.

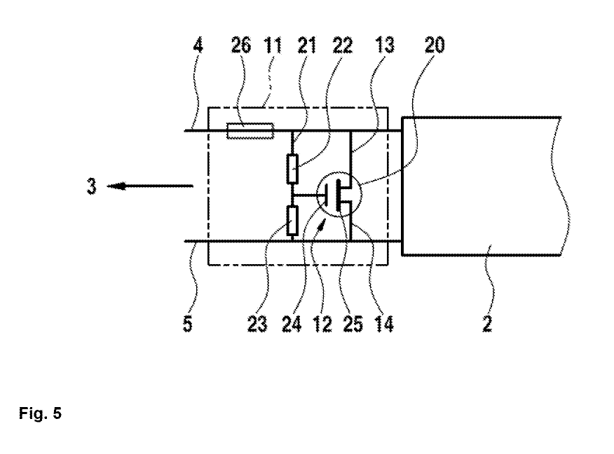

FIG. 5 depicts a fourth configuration of the circuit arrangement 11. According to it, a field effect transistor 20 is included in the first short-circuit bridge 12 as the first electrical component, with the load path of the field effect transistor 20 part of the short-circuit bridge 12. A control connection 25 of the field effect transistor 20 is electrically conductively connected to a pickup 24 to pick up a voltage between two electrical resistors 22, 23 connected to each other in series. The series connection of the two electrical resistors 22, 23 is included in a first bridge line 21 electrically connecting the two electrical lines 4, 5 to each other. The two electrical resistors 22, 23 are selected such that upon reaching the limiting voltage, a voltage is applied to the pickup 24, by which the load path of the field effect transistor 20 is switched to passage such that the two bridge sections 13, 14 and thus the two electrical lines 4, 5 are short-circuited.

In the configurations of the circuit arrangement 11 depicted in FIG. 2 through 5, a fuse 26 (for example, a safety fuse) is in each case arranged within the circuit arrangement 11 in the first line 4 connected to the power source 3, by which fuse the electric circuit between the power source 3 and the optically active glazing 2 is interrupted upon reaching a predetermined (selectable) threshold circuit strength, such that the optically active glazing 2 is protected in the event of damage or failure of the first electrical component. It would be equally possible to arrange the fuse 26 outside the circuit arrangement 11 inside the electric circuit connecting the power source 3 to the optically active glazing 2. It would also be conceivable, alternatively or additionally, to provide a dropping resistor to limit current in the electric circuit between the power source 3 and the optically active glazing 2.

The third and fourth configurations of the circuit arrangement 11 depicted in FIGS. 4 and 5 are, above all, suited for optically active glazing 2 with a relatively low operating voltage which, for example, amounts to a few volts such that its limiting voltage can accordingly lie in the range of a few volts.

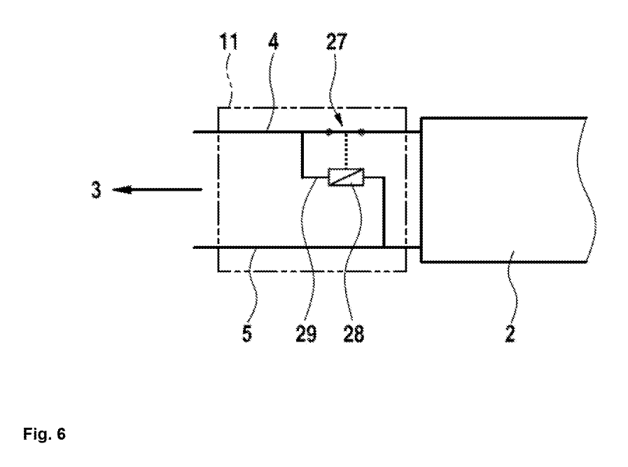

FIG. 6 depicts a configuration of the circuit arrangement 11 in which the electric circuit between the power source 3 and the optically active glazing 3 is interrupted upon reaching the limiting voltage of the optically active glazing 2. For this, a relay 27, actuated by an actuator 28, is arranged in the first line 4 connected to the power source 3. The actuator 28 is arranged in a second bridge line 29 that electrically conductively connects the two lines 4, 5 of the pair of lines connected to the power source 3 to each other. The actuator 28 is configured such that below the limiting voltage, it closes the relay 27 and upon reaching the limiting voltage, it opens the relay 27.

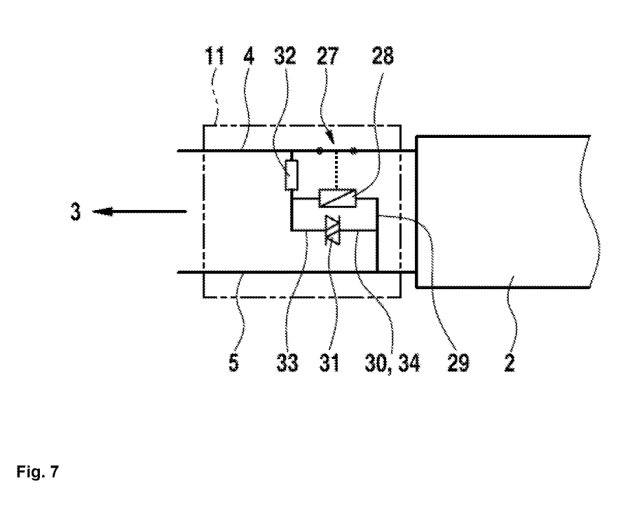

FIG. 7 depicts a variant of the circuit arrangement 11 of FIG. 6. Here, in addition, a third resistor 32 and a second short-circuit bridge 30 connected in parallel to the actuator 28, by which the two lines 4, 5 of the first pair of lines connected to the power source 3 can be electrically conductively connected to each other, are arranged. The second short-circuit bridge 30 has, as a third electrical component, a second diac 31 dividing the second short-circuit bridge 30 into a third bridge section 33 and a fourth bridge section 34. The breakdown voltage of the two diodes of the second diac 31 are selected here such that the two diodes of the second diac 31 become electrically conductive upon reaching a predetermined (selectable) threshold voltage such that the two bridge sections 33, 34 and thus the lines 4, 5 connected to the power source 3 are short-circuited. Alternatively, it would be equally possible to provide, as the third electrical component, a pair of antiserial-connected zener diodes whose breakdown voltages and the third resistor 32 are selected such that the zener diodes become electrically conductive upon reaching the threshold voltage.

In the configurations of the circuit arrangement 11 depicted in FIGS. 6 and 7, no fuse 26 is provided such that the electric circuit between the power source 3 and the optically active glazing 2 can be reversibly interrupted upon reaching the limiting voltage of the optically active glazing 2.

In the present invention, all embodiments or configurations explained above can be combined with each other, with advantageous effects obtainable thereby, in particular a universally usable overvoltage protection for an optically active glazing whose operating voltage can selectively be relatively high (several hundred volts) or relatively low (several volts).

### LIST OF REFERENCE CHARACTERS

1 construction
2 optically active glazing
3 power source
4 first line
5 second line
6 distributor
7 blade terminal
8 first substrate
9 layer sequence
10 second substrate
11 circuit arrangement
12 first short-circuit bridge
13 first bridge section
14 second bridge section
15 first diac
16 spark gap
17 bipolar transistor
18 control connection
19 diode
20 field effect transistor
21 first bridge line
22 first resistor
23 second resistor
24 pickup
25 control connection
26 fuse
27 relay
28 actuator
29 second bridge line
30 second short-circuit bridge
31 second diac
32 third resistor
33 third bridge section
34 fourth bridge section

1. A construction, comprising:
i) at least one optically active glazing, wherein at least one optical property of the at least one optically active glazing can be varied by supplying electrical power,
ii) an electrical power source electrically connected via an electric circuit to the at least one optically active glazing, wherein the electric circuit comprises:
a first pair of lines connected to the electrical power source, and
a circuit arrangement electrically connected to the electrical power source via the first pair of lines and configured such that, below a predetermined limiting voltage, the circuit arrangement electrically connects the electrical power source and the at least one optically active glazing and, upon reaching the predetermined limiting voltage, the circuit arrangement electrically isolates the electrical power source from the at least one optically active glazing.

2. The construction according to claim 1, wherein the circuit arrangement is arranged inside the electric circuit closer to the at least one optically active glazing than to the electrical power source.

3. The construction according to claim 1, wherein:
the electric circuit comprises an electrical distributor provided with a housing,
the electrical distributor electrically conductively connects the first pair of lines to at least one second pair of lines or at least one pair of contacts connected to the at least one optically active glazing, and
the circuit arrangement is integrated into the housing of the electrical distributor.

4. The construction according to claim 1, wherein:
the electric circuit comprises an electrical distributor provided with a housing,
the electrical distributor electrically conductively connects the first pair of lines to at least one second pair of lines or at least one pair of contacts, and
the circuit arrangement is configured to be connected to input connectors of the electrical distributor.

5. The construction according to claim 1, wherein:
the circuit arrangement comprises a first short-circuit bridge configured to electrically conductively connect two lines of the first pair of lines,
the first short-circuit bridge comprises at least one first electrical component configured to divide the first short-circuit bridge into two bridge sections, and
the at least one first electrical component is configured such that, below the predetermined limiting voltage, the at least one first electrical component electrically isolates the two bridge sections and, upon reaching the predetermined limiting voltage, the at least one first electrical component electrically conductively connects the two bridge sections.

6. The construction according to claim 5, wherein the at least one first electrical component comprises a spark gap.

7. The construction according to claim 5, wherein the at least one first electrical component comprises at least one pair of antiparallel-connected diodes.

8. The construction according to claim 5, wherein the at least one first electrical component comprises at least one pair of antiserial-connected zener diodes.

9. The construction according to claim 5, wherein:
the at least one first electrical component comprises at least one transistor,
a control connection of the at least one transistor is connected to at least one of the two lines of the first pair of lines via a second electrical component,
the second electrical component is configured such that the control connection applies a control voltage upon reaching the predetermined limiting voltage, and
the control voltage switches on the at least one transistor.

10. The construction according to claim 9, wherein:
the control connection is electrically conductively connected to a pickup of a voltage divider,
the voltage divider is arranged in a first bridge line connecting the two lines of the first pair of lines to each other and configured such that, upon reaching the predetermined limiting voltage, a voltage is applied to the pickup, and
the voltage switches on the at least one transistor.

11. The construction according to claim 9, wherein the second electrical component comprises at least one diode, and wherein a forward voltage of the at least one diode is selected such that the at least one transistor switches on upon reaching the predetermined limiting voltage.

12. The construction according to claim 5, wherein the electric circuit electrically connecting the electrical power source with the at least one optically active glazing is provided with a fuse, and wherein operation of the electric circuit is interrupted by the fuse when the electric circuit reaches a predetermined threshold current strength.

13. The construction according to claim 1, wherein:
the circuit arrangement comprises a relay actuated by an actuator,
the relay is arranged between the electrical power source and the at least one optically active glazing,
the electric circuit can be interrupted between the electrical power source and the at least one optically active glazing by the relay,
the actuator is arranged in a second bridge line that electrically connects two lines of the first pair of lines and is configured such that, below the predetermined limiting voltage, the actuator closes the relay and, upon reaching the predetermined limiting voltage, the actuator opens the relay.

14. The construction according to claim 13, further comprising a second short-circuit bridge connected in parallel to the actuator, wherein:
the two lines of the first pair of lines can be electrically conductively connected via the second short-circuit bridge,
the second short-circuit bridge has at least a third electrical component configured to divide the second short-circuit bridge into two bridge sections, and
the third electrical component is configured such that, below a predetermined threshold voltage, the third electrical component electrically isolates the two bridge sections and, upon reaching the predetermined threshold voltage, the third electrical component connects the two bridge sections electrically conductively.

15. The construction according to claim 1, wherein the at least one optically active glazing is an electrochromic glazing, and wherein transparence of the at least one optically active glazing can be varied by supplying electrical power.

16. The construction according to claim 2, wherein the circuit arrangement is arranged inside the electric circuit closer to the at least one optically active glazing than to the electrical power source, and wherein the circuit arrangement is in an immediate vicinity of the at least one optically active glazing.
